(19) United States
(12) Patent Application Publication
(10) Pub. No.: US 2026/0149066 A1
(43) Pub. Date: May 28, 2026

(54) CHARGING ARCHITECTURE AND METHOD FOR PORTABLE DEVICES

(71) Applicant: Datalogic IP Tech S.R.L., Lippo Di Calderara Di Reno (IT)

(72) Inventors: Giuseppe Pio FRASCOLLA, Bologna (IT); Francesco PUGLIESE, Bologna (IT); Marco PIFFERI, San Cesario sul Panaro (IT)

(21) Appl. No.: 18/962,794

(22) Filed: Nov. 27, 2024

(51) Int. Cl. H01M 10/42; H02J 7/00

(52) U.S. Cl. CPC H01M 10/4257; H02J 7/44; H02J 7/80; H02J 7/94; H02J 7/96; H02J 7/975; H01M 2010/4278

(57) ABSTRACT

The technology disclosed herein relates to a battery pack and battery charging interface, as well as techniques associated with the battery pack. For example, the battery pack may comprise a battery cell, computer-readable storage media having computer-executable instructions embodied thereon that trigger an operation by a charging device, and a connector that provides a signal to the charging device to trigger the operation by the charging device. In some embodiments, the battery pack may not include a processor. As another example, the battery charging interface may comprise a first charging path associated with a first external adapter, an internal charging platform of a mobile device, and a controller of the mobile device, and a second charging path associated with a second external adapter, an external charging platform that is external to the mobile device, and the controller of the mobile device.

### BACKGROUND

Charging units may be configured to charge batteries (e.g., in fixed configurations). For example, the charging unit may provide electrical energy to the battery, usually in the form of Direct Current (DC) voltage. The charging unit may sometimes monitor voltage increases as the battery charges. The charging unit can supply a range of voltages (e.g., from 5V to 20V) and currents (e.g., up to 5 A) based on particular device (e.g., a particular cell phone) requests.

A constant current/constant voltage (CC/CV) charging profile may be a particular method for charging lithium-ion (Li-ion) and lithium-polymer (LiPo) batteries. These profiles can vary depending on manufacturer, model, and charging protocol (e.g., universal serial bus power delivery (USB PD)). In a constant current phase, the charging unit supplies a constant current while the battery voltage gradually increases. In a constant voltage phase, the voltage is held constant while the current gradually decreases.

By way of background, issues with device charging or inefficiencies with charging can arise from various factors related to charger or battery design and usage, as well as the circuitry within the device being charged. By way of example, issues may include overheating, overcharging, or short circuits (e.g., due to faults in the charger, battery, or the device itself). As another example, charging units are typically in control over the operations of the charging of the device, which can lead to overheating of the device being charged (e.g., based on the charging unit having improper voltage and current regulation). As another example, charging units in control over the operations of the charging of the device may lack the proper circuitry to stop or reduce charging once the battery has fully charged. These situations can lead to battery degradation, reduced battery capacity, reduced battery lifespan, thermal damage to the battery, damage to the internal structure of the battery, loss of battery charge retention, etc.

### SUMMARY

This summary provides a high-level overview of various aspects of the technology disclosed herein, and the detailed-description section below provides further description herein. This summary is not intended to identify key features or essential features of the claimed subject matter, nor is it intended to be used as an aid in isolation to determine the scope of the claimed subject matter. The present disclosure is directed, in part, to technology associated with components, methods, systems, media, etc., for a battery pack that controls a charging phase of a battery, substantially as shown in and/or described in connection with at least one of the figures, and as set forth more completely in the claims.

In embodiments, a battery pack may comprise computer-readable storage media having computer-executable instructions embodied thereon that trigger an operation by a charging device. Stated differently, the computer storage media of the battery pack may control operations of the charging device (e.g., increasing or decreasing the power received by the battery pack from the charging device). By way of illustration, the technology disclosed herein includes embodiments for a high efficiency charging architecture for a battery pack (e.g., a mobile device having a battery pack) and method for controlling the charging of the battery pack from the battery pack itself (e.g., rather than from the charging device).

The battery pack may comprise a battery cell and a connector (e.g., an input/output (I/O) pin component), such that the battery pack can provide a signal to the charging device to trigger the operation by the charging device (e.g., the operation of the charging device being to begin providing power to the battery pack). For example, the connector may transmit signals, which cause different charging device operations by the charging device. The computer-readable storage media of the battery pack may trigger synchronous or asynchronous operations by the charging device. In this way, the charging device will perform commands provided by the battery pack.

In embodiments, the battery pack may also comprise a battery gauge (e.g., the battery gauge being located inside a housing of the battery pack) that measures battery parameters (e.g., a voltage, current, or temperature corresponding to the battery). The battery parameters may be measured based on a specific sensing line and a power line, both of which run between a battery gauge and battery cell. The battery parameters measured by the battery gauge may be provided by the battery pack to a processor of the charging device, such that the charging device performs charging operations based on these battery parameters (e.g., the charging operations also being performed based on the instructions from the battery pack). In this way, voltage sensing may be performed close to the battery cell for accurate voltage setting of the charging device.

Additionally, the power supply may be programmable to adapt various power supply outputs to a particularly selected charging profile, such that total power losses on the charging path are reduced and overheating is avoided. For example, the charging profile may be stored within the computer-readable media of the battery pack. As another example, the charging device may charge a first battery pack according to a first charging profile based on the instructions provided by the computer-readable storage media of the first battery pack, and the charging device may also charge a second battery pack according to a second charging profile based on the instructions provided by the computer-readable storage media of the second battery pack. In embodiments, the charging profiles may be altered or updated through a bus connecting the battery gauge of the battery pack and the computer-readable storage media of the battery pack.

The charging device may comprise a charging device connector for an electrical connection with the battery pack through the connector of the battery pack. The charging device connector may have a first connector component that forms a first line with a power supply of the charging device, a second connector component that forms a second line with the power supply and a processor of the charging device, and a third connector component having a third line with the processor. Upon the charging device connector establishing the electrical connection with the battery pack, the first line of the charging device may be communicatively coupled with the battery gauge of the battery pack, the second line of the charging device may be communicatively coupled with the gauge and the computer-readable storage media of the battery pack, and the third line of the charging device may be communicatively coupled with the gauge of the battery pack. In this way, the processor of the charging device may be controlled by the computer-readable storage media of the battery pack (e.g., based on the processor of the charging device receiving an interrupt signal from the battery pack, based on battery cell parameters measured by the gauge of the battery pack). For example, the charging device processor may receive signals from the battery pack that trigger charging device operations.

In addition, battery charging interfaces between an external charging platform and a mobile device having an internal charging platform are provided. For example, a battery charging interface may comprise a first charging path associated with the internal charging platform of the mobile device and a controller of the mobile device. The battery charging interface may also comprise a second charging path associated with the controller of the mobile device and the external charging platform. The controller can disable charging by the internal charging platform of the mobile device upon detection of the external charging platform, such that the charging by the external charging platform can be enabled upon disabling or stopping charging by the internal charging platform. In embodiments, a processor of the internal charging platform may still be enabled while the charging by the internal charging platform is disabled, such that the processor of the internal charging platform determines a status of the battery cell as the mobile device is being charged by the external charging platform. In embodiments, the internal charging platform may be disabled based on operating instructions stored in computer-readable storage media of the battery pack that indicate the external charging platform has a higher priority than the internal charging platform.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Implementations of the present disclosure are described in detail below with reference to the attached drawing figures, wherein:

FIGS. 1-4 depict example diagrams of a battery pack and charging device prior to initiating charging of a battery cell in the battery pack, in accordance with embodiments herein;

FIG. 5 depicts an example diagram of a battery pack and charging device as charging of a battery cell in the battery pack is enabled, in accordance with embodiments herein;

FIG. 6 depicts an example battery pack and charging device environment for battery pack operating instructions that control a charging phase of the battery, in accordance with embodiments herein;

FIG. 7A depicts an example charging device embodiment and FIG. 7B depicts an example battery pack embodiment, in accordance with embodiments herein;

FIG. 8 depicts another example embodiment of the battery pack and charging device, in accordance with embodiments herein;

FIGS. 9A-9B illustrate example graphs that compare charging performances of the presently disclosed technology to another current technology, in accordance with embodiments herein;

FIG. 10 illustrates an example flowchart for initiating a charging phase of the battery pack based on operating instructions from the battery pack, in accordance with embodiments herein; and

FIGS. 11-16 illustrate example embodiments of battery charging interfaces.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies.

### Terms

Although the terms “step” and/or “block” may be used herein to connote different elements of methods employed, the terms should not be interpreted as implying any particular order among or between various steps herein disclosed unless and except when the order of individual steps is explicitly described.

In addition, words such as “a” and “an,” unless otherwise indicated to the contrary, may also include the plural as well as the singular. Thus, for example, the constraint of “a feature” is satisfied where one or more features are present.

Furthermore, the term “or” includes the conjunctive, the disjunctive, and both (a or b thus includes either a or b, as well as a and b).

“Computer storage media” does not comprise signals per se.

Unless specifically stated otherwise, descriptors such as “first,” “second,” and “third,” for example, are used herein without imputing or otherwise indicating any meaning of priority, physical order, arrangement in a list, or ordering in any way, but are merely used as labels to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

Further, the term “some” may refer to “one or more.” Additionally, an element in the singular may refer to “one or more.” The term “plurality” may refer to “more than one.”

The term “combination” (e.g., one or more combinations thereof) may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

As used herein, the phrase “based on” shall be construed as a reference to an open set of conditions. For example, an example step that is described as “based on X” may be based on both X and additional conditions, without departing from the scope of the present disclosure. In other words, as used herein, the phrase “based on” shall be construed in the same manner as the phrase “based at least in part on.”

In addition, a “battery cell” may be a battery cell capable of storing and delivering electrical energy, such as a lithium-ion battery, a lithium polymer battery, a nickel cadmium battery, a nickel metal hydride battery, a lithium high voltage battery, another type of battery cell, etc.

Additionally, a “mobile device” as used herein may be a cellular phone, a smartphone, a pager, a scanner capable of converting captured analog data or another type of data into digital data, a wearable device, mobile barcodes scanners generally used to read optical information, another type of mobile device, etc.

A “battery pack” may be capable of providing a particular voltage and capacity for powering devices. In embodiments, a battery pack may include a plurality of battery cells connected in series, parallel, or a combination of both.

Embodiments of the technology described herein may be embodied as, among other things, a method, system, or computer-program product. Accordingly, the embodiments may take the form of a hardware embodiment, or an embodiment combining software and hardware. An embodiment that takes the form of a computer-program product can include computer-useable instructions embodied on computer-readable media.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to random access memory (RAM), read only memory (ROM), electrically erasable programmable read only memory (EEPROM), flash memory or other memory technology, compact disc ROM (CD-ROM), digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

### Overview

The present technology discussed herein provides for various improvements over the previous technologies discussed above. For example, the technology discussed herein can provide advantages associated with prevention of reduced battery lifespan, prevention of thermal damage to the battery, etc. To illustrate, embodiments disclosed herein relate to the battery pack controlling the charging phase (rather than the charging device controlling) through operating instructions provided by computer-readable storage media of the battery pack. Embodiments disclosed herein also include battery parameter measurements (e.g., voltage sensing) performed close to the battery cell (e.g., based on a sensing line), allowing more accurate voltage settings of charging unit while charging the battery pack.

In these ways, the charging unit does not require a redesign, and various types of charging devices having different capabilities can be used to charge the battery pack, since the operating instructions are provided by the computer-readable storage media of the battery pack. In addition, the technology disclosed herein reduces power losses on the charging path, avoiding charging limitations due to overheating of the battery pack. Furthermore, the battery charging interface described herein provides for customization of the charging current, charging profile, and improve thermal performances, thereby maintaining compatibility of external charging platforms with the internal charging platform of the device.

### Technological Embodiments

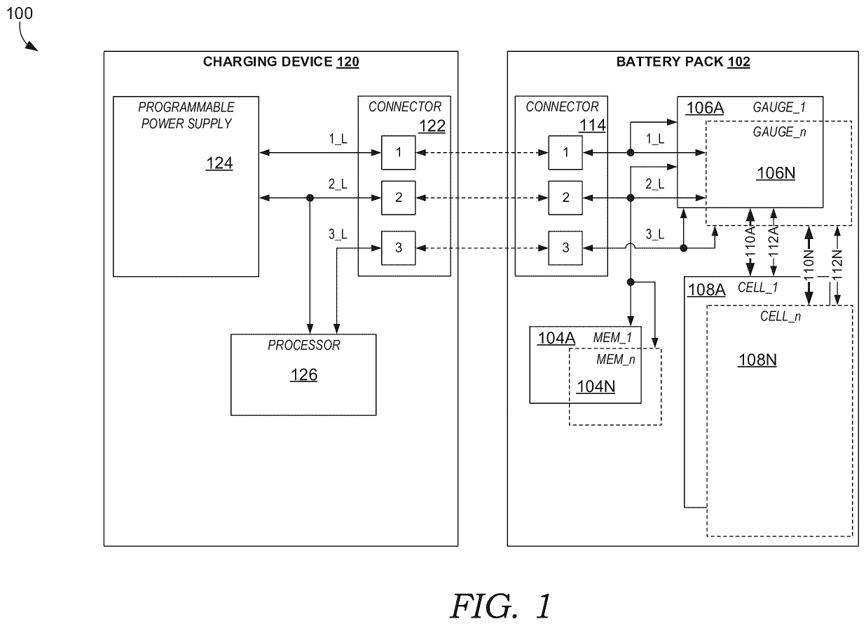

FIG. 1 illustrates example diagram 100 including a battery pack and charging device prior to initiating charging of a battery cell in the battery pack. Example diagram 100 is but one example of a suitable device for the technology and techniques disclosed herein, and is not intended to suggest any limitation as to the scope of use or functionality of the invention. Neither should the diagram 100 be interpreted as having any dependency or requirement relating to any one or combination of components illustrated.

The example diagram 100 comprises battery pack 102 having one or more computer-readable media (e.g., computer-readable medium 104A . . . computer-readable medium 104N), one or more battery gauges (e.g., battery gauge 106A . . . battery gauge 106N), one or more battery cells (e.g., battery cell 108A . . . battery cell 108N), and connector 114. The battery pack 102 may have a specific sensing line and a power line between each battery gauge and battery cell (e.g., specific sensing line 112A between battery gauge 106A and battery cell 108A, specific sensing line 112N between battery gauge 106N and battery cell 108N, power line 110A between battery gauge 106A and battery cell 108A, power line 110N between battery gauge 106N and battery cell 108N). The connector 114 may comprise a first connector component having a first line (1_L) with the battery gauge (e.g., battery gauge 106A), a second connector component having a second line (2_L) with the battery gauge (e.g., battery gauge 106A) and the computer-readable media (e.g., computer-readable medium 104A), and a third connector component having a third line (3_L) with the battery gauge (e.g., battery gauge 106A).

In embodiments, the battery cells (e.g., battery cell 108A . . . battery cell 108N) may each be connected in different configurations (e.g., 1S2P (the voltage is the same as a single cell and two cells connected in parallel), 2S1P (two cells connected in series and one set in parallel), 2S2P (“S” referring to series and “P” referring to parallel), etc.). The one or more battery gauges (e.g., battery gauge 106A . . . battery gauge 106N) may perform battery parameter measurements of the battery cell (e.g., battery cell 108A . . . battery cell 108N). The battery parameter measurements may include a state of charge (e.g., remaining battery cell capacity), state of health of the battery, the voltage or electrical potential difference across battery terminals of the battery cell, current, battery temperature, battery capacity, charge or discharge rate, cycle count, resistance, state of power, time to empty, time to full, etc. The battery gauge may use voltage and current sensors to measure a voltage current of the battery cell and/or to measure the voltage and/or current coming from the power source through the connector 114. In embodiments, the voltage may be measured based on the specific sensing line 112A. In embodiments, the battery gauge may include an integrated gauge, a discrete gauge, resistive dividers, integrated circuits, analog-to-digital converters, etc., or one or more combinations thereof.

The one or more computer-readable media (e.g., computer-readable medium 104A . . . computer-readable medium 104N) of the battery pack 102 may store charging configuration data (e.g., lithium-ion charging profiles, nickel-metal hydride charging profiles, fast charging phase data, top-off charging phase data, bulk charge data, constant current data, constant voltage data, charging profiles based on battery chemistry, temperature management, battery age, battery condition, other types of charging configuration data, etc.). In embodiments, the charging profiles are pre-loaded in read-write memory inside the battery pack (e.g., inside a housing of the battery pack). A charging profile is a set of configuration data and instructions used by the charging device 120 to trigger and manage the charging of the battery pack 102. The charging profiles may be changed or updated through the second line (2_L) (a data bus between the battery gauge (e.g., battery gauge 106A) and the computer-readable media (e.g., computer-readable medium 104A)). The operations of updating the charging profiles may be performed in factory or by the end user or by recurrent updates of the charging device.

The specific sensing line (e.g., specific sensing line 112A) may transmit voltage data of the battery cell (e.g., battery cell 108A) to the processor 126 of the charging device 120 using a digital bus (2_L) between the battery pack 102 and the charging device 120. In embodiments, the electrical parameters of the battery cell may be monitored by the battery gauge by means of both power and sensing lines. For instance, the battery voltage may be measured only using the sensing line, while the battery state of charge (SoC) is being measured by “counting” the electrical current that passes on power line in correlation with the voltage sensed on sensing line (e.g., specific sensing line 112A).

The power line (e.g., power line 110A), in some embodiments, may be used for charging the battery cell 108. In embodiments, the power line may be used to monitor a state of charge for the battery cell, remaining capacity of the battery cell, etc. The power line may receive power from the charging device 120 through the first line (1_L) between the battery pack 102 and the charging device 120. Power from the charging device 120 can be transmitted through the first line (1_L) by means of contacts (wired) or electromagnetic field (Wireless Power Transfer).

The connector 114 may receive power through the first line (1_L) based on the first connector component. The connector 114 may also have a specific input/output pin (e.g., the third connector component) that is used for mastering the charging phase through the third line (3_L). Stated differently, the third connector component of the connector 114 may be connected with a charging device connector 122 of the charging device 120 to provide signals to the processor 126 of the charging device 120.

The charging device 120 includes a charging device connector 122, power supply 124, and processor 126. The charging device connector 122 may comprise a first connector component that forms a first line (1_L) with the power supply 124 of the charging device 120, a second connector component that forms a second line (2_L) with the power supply 124 and the processor 126, and a third connector component having a third line (3_L) with the processor 126. Upon the charging device 120 establishing a connection with the battery pack 102 through the connector 114 and the charging device connector 122, the battery cell (e.g., battery cell 108A) of the battery pack 102 may receive power from the power supply 124 through the first line (1_L) based on operating instructions from the battery pack 102.

The processor 126 can monitor the state of the battery cell power or the other battery parameter readings based on the digital bus (e.g., 2_L). As another example, the sensing lines (e.g., specific sensing line 112A and power line 110A associated with battery cell 108A) may also be monitored by the processor 126 based on the digital bus. In embodiments, these parameters may be stored in the memory (e.g., computer-readable media 104A). In embodiments, the signals provided by the memory of the battery pack (e.g., computer-readable media 104A) may be used to manage the charging phase through the third line (3_L) and to give commands through a digital bus (e.g., 2_L) to the power supply 124. The power supply 124 may deliver power through a power path (1_L) based on the operations by the processor 126 (e.g., the processor being instructed by the operating instructions from the memory of the battery pack 102).

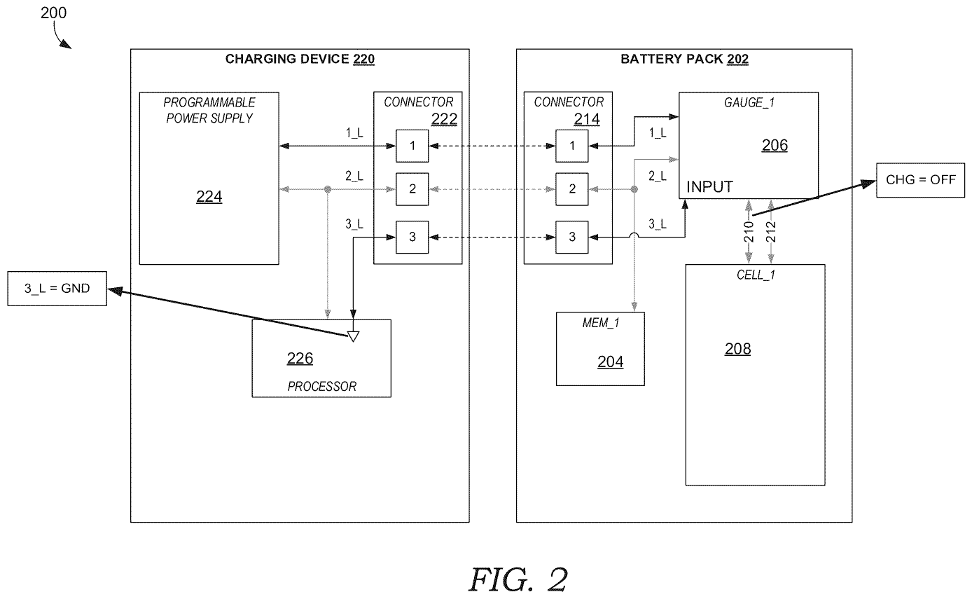

FIG. 2 includes example diagram 200, which comprises battery pack 202 and charging device 220 prior to initiating charging of a battery cell 208 in the battery pack 202. The battery pack 202 includes computer-readable media 204, battery gauge 206, specific sensing line 212, power line 210, battery cell 208, and connector 214. The charging device 220 includes charging device connector 222, power supply 224, and processor 226.

In embodiments, prior to initiating charging, the 3_L line connected to the battery gauge 206 is set as an INPUT (e.g., so an input pin can't transmit a signal). By disabling the charging at the initiating phase, short circuit or electrical damage can be avoided when the battery pack 202 is inserted on the charging device 220 and as the electrical levels of the power lines 1_L are unknown.

The input pin of the battery gauge 206 (e.g. ALERT_IN) senses the state of the 3_L line. Since the processor is taking low the 3_L line, the gauge interprets the logic level 0 (GND) as a charging-off command associated with the third connector component of the connector 214 and the third connector component of the connector 222 before charging phase of the battery cell 208 begins. Based on this transmission, the third line (3_L) is taken low (GND) to disable charging.

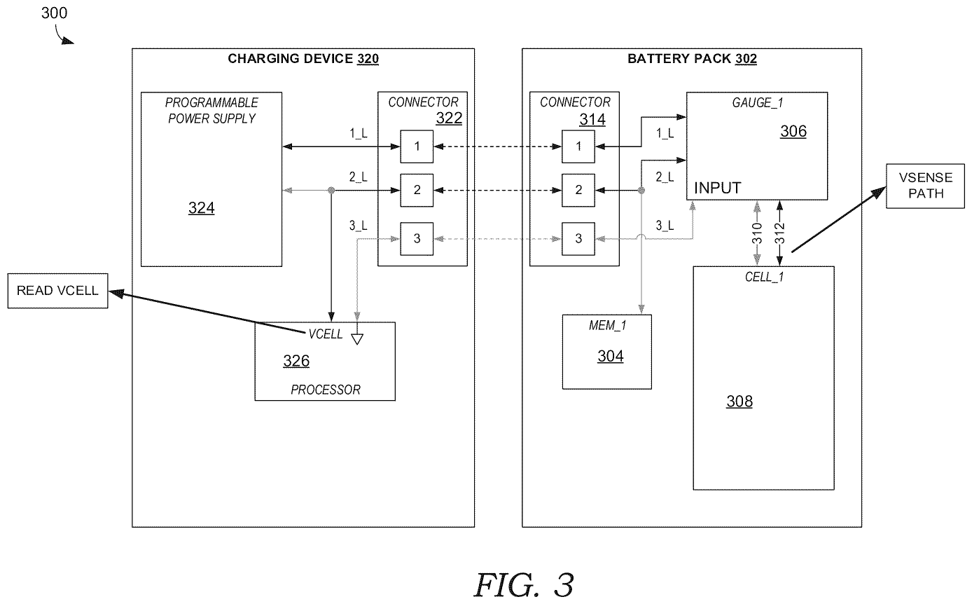

FIG. 3 includes example diagram 300, which comprises battery pack 302 and charging device 320 prior to initiating charging of a battery cell 308 in the battery pack 302. The battery pack 302 includes computer-readable media 304, battery gauge 306, specific sensing line 312, power line 310, battery cell 308, and connector 314. In embodiments, the battery pack 302 does not include a processor. The charging device 320 includes charging device connector 322, power supply 324, and processor 326.

The processor 326 may read battery voltage parameters of the battery cell 308 based on the charging device 320 transmitting a voltage reading request on the digital bus (e.g., the second line (2_L) associated with the second connector component of connector 322 and the second connector component of connector 314). Voltage measurements may be captured by the battery gauge 306 using specific sensing line 312 that transmits voltage data (Vbatt) of the battery cell 308 to the processor 326 using the digital bus (2_L).

For example, the battery gauge 306, which may be located inside a housing of the battery pack 302, may measure battery parameters of the battery cell 308 (e.g., current, capacity, voltage, etc.) based on a sensing line connection (e.g., specific sensing line 312) between the battery gauge 306 and the battery cell 308 and based on the power line (e.g., power line 310) between the battery gauge 306 and the battery cell 308.

As another example, the second line (2_L) within the battery pack 302 may be connected with the charging device connector 322 of the charging device 320 to provide voltage measurements to the processor 326 of the charging device 320. In yet another example, the battery pack 302 may transmit, through the second line (2_L) from the battery pack, voltage measurement data and temperature data measured by the battery gauge 306 of the battery pack 302 to the processor 326 of the charging device 320.

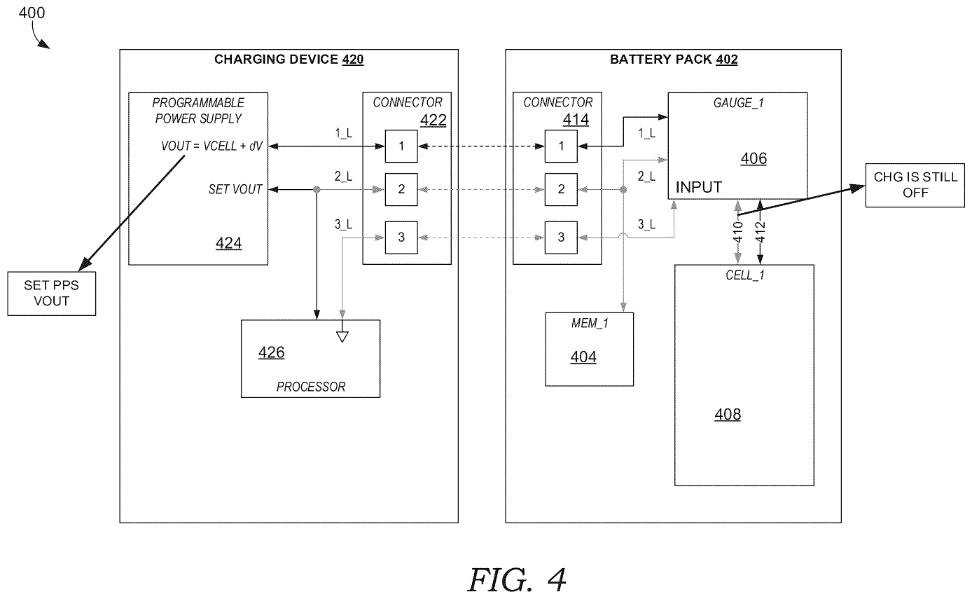

FIG. 4 includes example diagram 400, which comprises battery pack 402 and charging device 420 prior to initiating charging of a battery cell 408 in the battery pack 402. The battery pack 402 includes computer-readable media 404, battery gauge 406, specific sensing line 412, power line 410, battery cell 408, and connector 414. In embodiments, the battery pack 402 does not include a processor. The charging device 420 includes charging device connector 422, power supply 424, and processor 426.

The processor 426 may set the voltage output, using the first line between the connector 422 and the power supply 424 (1_L), of power supply 424 (e.g., setting the voltage output as Vout=Vbatt+ΔV). In embodiments, the processor 426 may set the voltage output prior to initiation of the charging of the battery cell 408. Prior to enabling the charging, the power line 410 between the battery cell 408 and the battery gauge 406 is disabled.

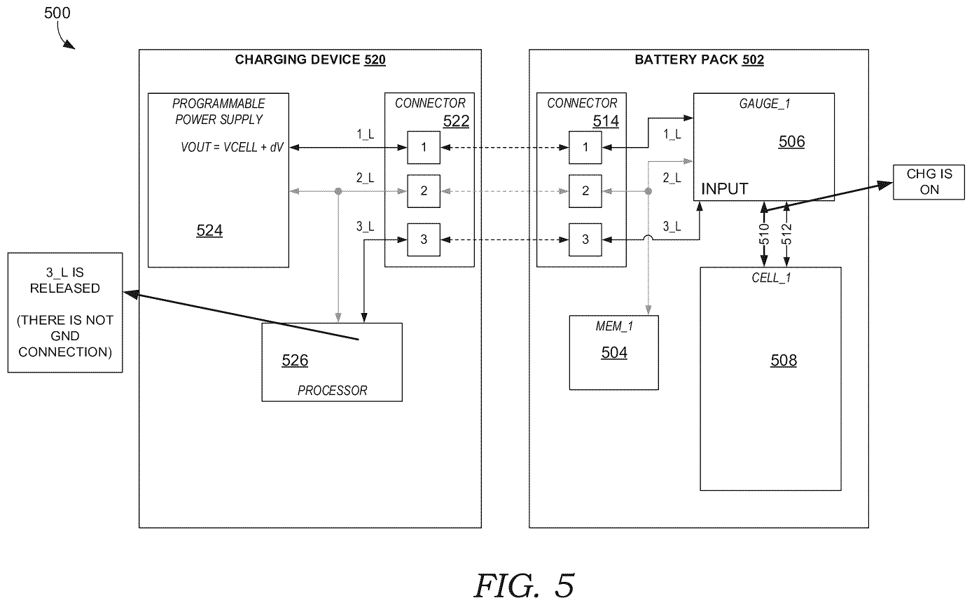

FIG. 5 includes example diagram 500, which comprises battery pack 502 and charging device 520 associated with enabling charging of a battery cell 508 in the battery pack 502. The battery pack 502 includes computer-readable media 504, battery gauge 506, specific sensing line 512, power line 510, battery cell 508, and connector 514. In embodiments, the battery pack 502 does not include a processor. The charging device 520 includes charging device connector 522, power supply 524, and processor 526. The third line (3_L) is released (HI-Z), thereby enabling charging. For example, prior to enabling the charging, the power line between the battery cell and the battery gauge is disabled. Upon enabling the charging, the power line 510 between the battery cell 508 and the battery gauge 506 is enabled. As another example, the third line (3_L) may be associated to a charge-on command or another type of digital signal.

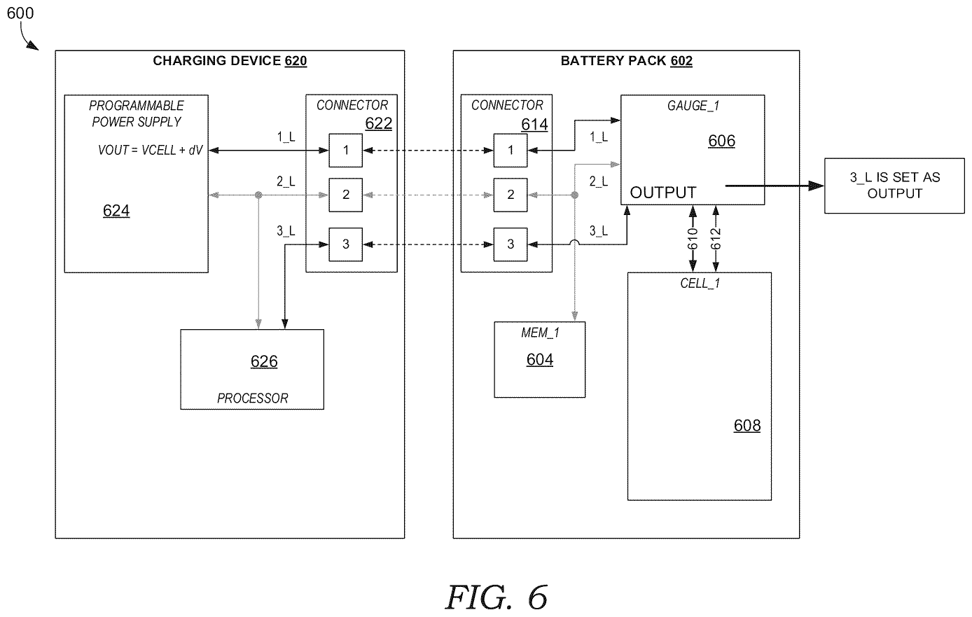

FIG. 6 depicts example diagram 600, which comprises battery pack 602 and charging device 620, the diagram 600 corresponding to battery pack operating instructions that control the charging of the battery cell 608. The battery pack 602 includes computer-readable media 604, battery gauge 606, specific sensing line 612, power line 610, battery cell 608, and connector 614. In embodiments, the battery pack 602 does not include a processor. The charging device 620 includes charging device connector 622, power supply 624, and processor 626.

The pin of the battery gauge 606 (connected to the third line (3_L)) may be set as battery pack output to allow battery pack 602 to control the charging phase (e.g., the battery pack 602 controls the operations of the processor 626, such that the processor 626 executes commands from operating instructions provided by the computer-readable media 604). In this way, the battery pack 602 may transmit an interrupt signal (e.g., through the third line) to the processor 626 (e.g., the interrupt signal being ALRT_OUT), such that the battery pack 602 may cause the charging device 620 to increase or decrease charging power. As such, when the third line (3_L) interrupt signal (ALRT_OUT) is asserted, battery registers are read through the digital bus (2_L), such that the point 6 of the pseudo-code shows that registers are reading register only when the interrupt signal (coming from battery pack 602) is asserted, and such that the charging device 620 remains in a stationary state until the battery pack 602 provides (through the third line) operating instructions from the computer-readable media 604 to the processor 626.

Stated differently, the connector 614 may transmit a signal to the processor 626 of the charging device 620 to trigger an operation by the charging device 620 (e.g., an operation to provide the battery pack 602 with power). For example, the signal may be transmitted to the processor 626 through the third connector component of the connector 614, and from the third line (3_L) of the battery pack 602 and through the third line (3_L) of the charging device 620. In addition, based on transmitting the signal, the battery pack 602 may receive, through the connector 614, power from the charging device 620. For instance, the power may be received through the first component of the connector 614, through the first line of the battery pack 602, through the power line 610, and to the battery cell 608.

In embodiments, battery parameters may be transmitted to the processor 626 through the second line based on the transmission of the interrupt signal (e.g., ALRT_OUT). For example, the connector 614 of the battery pack 602 may transmit voltage measurement data (or other battery parameters) measured by a battery gauge 606 of the battery pack 602 to the processor 626 of the charging device 620 prior to or upon receipt of the power. Based on the voltage measurement data or other battery parameters, the connector 614 of the battery pack 602 may transmit an instruction to the processor 626 of the charging device 620 to increase or decrease the power so that the battery cell 608 receives increased power from the charging device 620.

As another example, based on the temperature of the battery cell 608 being below a threshold (e.g., measured by the battery gauge 606), the connector 614 of the battery pack 602 may transmit an instruction to the processor 626 of the charging device 620 to decrease the power so that the battery cell 608 receives less power from the charging device 620. In yet another example, based on voltage measurement data and temperature data, the battery pack 602 may transmit an instruction to the processor 626 of the charging device 620 to decrease the power, such that the battery cell 608 receives decreased power from the charging device 620.

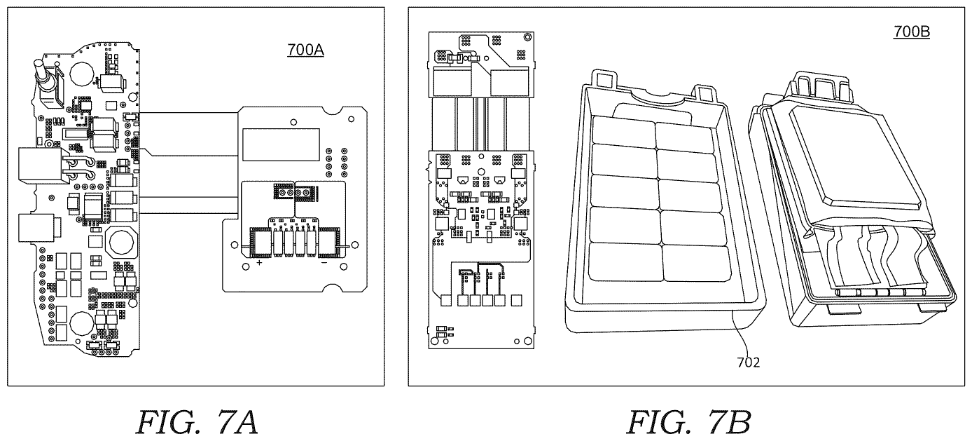

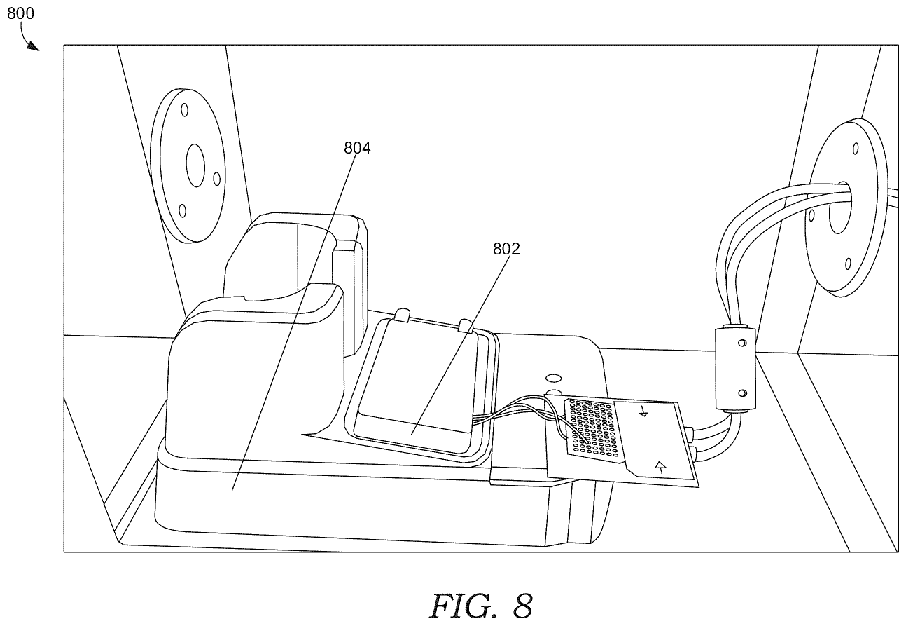

FIG. 7A depicts an example charging device embodiment 700A and FIG. 7B depicts an example battery pack embodiment 700B comprising a housing 702. In embodiments, the computer-readable media, battery gauge, specific sensing line, power line, and battery cell of the battery pack may be located within the housing 702. FIG. 8 depicts another example embodiment of the charging system 800 comprising the battery pack 802 and charging device 804. For example, FIG. 8 depicts the charging of a battery pack 802 on a spare slot of the charging device 804 docking cradle (e.g., for barcode scanner charging. In mobile code readers or other battery-operated devices, for example of the hand-held type, the battery may be charged often. Conventionally, this task is performed by placing the reader on a charging cradle or base station to provide energy to the battery when the reader is placed on the charging cradle.). The charging system 800 includes the charging circuity described above with respect to FIGS. 1-6.

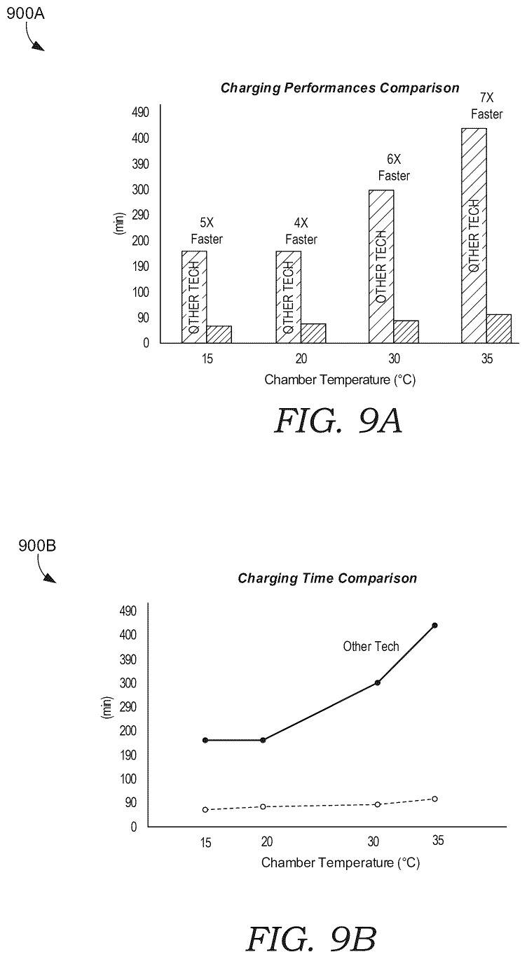

FIG. 9A illustrates example graph 900A that compares charging performances of the charging system 800 of FIG. 8 to another current technology (different from the technology described herein), and FIG. 9B illustrates example graph 900B that compares charging times of the charging system 800 of FIG. 8 to another current technology (different from the technology described herein).

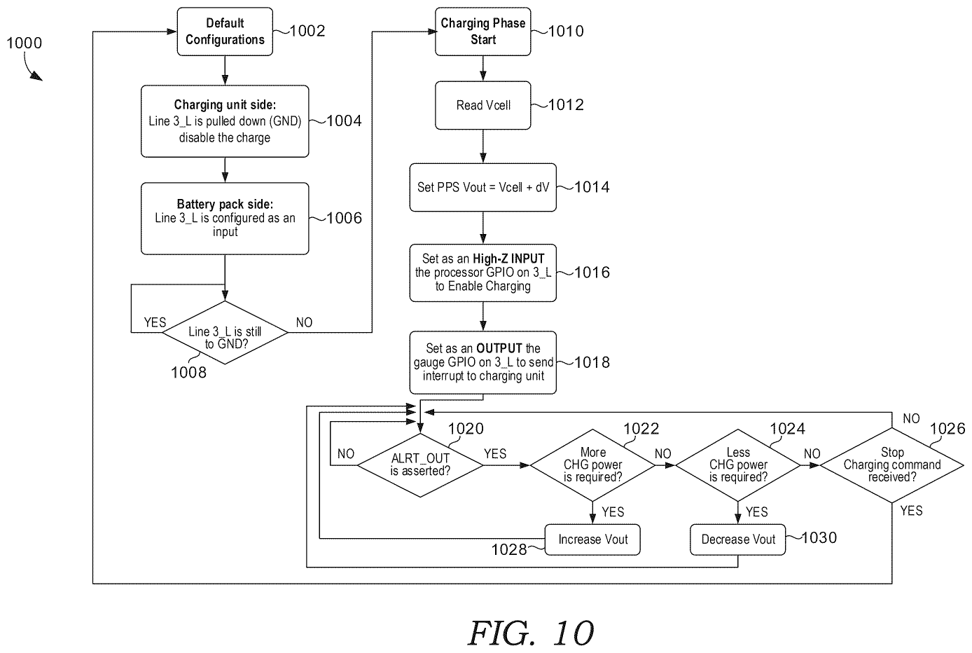

FIG. 10 illustrates an example flowchart 1000 for the charging of the battery pack based on the battery pack controlling the charging device. At step 1002, default configurations are identified. For example, the default configurations may be stored within computer-readable media of the battery pack.

At step 1004, the third line (e.g., the third line in FIGS. 1-6) is pulled down (ground “GND”) to disable the charging device (e.g., charging device 220 of FIG. 2, and 3_L=GND).

At step 1006, the third line is configured as an input for the battery pack (e.g., the battery pack 202 of FIG. 2 having the input associated with the battery gauge 206).

At step 1008, a determination is made as to whether the third line is still grounded. If the third line is not grounded, the charging phase begins at step 1010. At step 1012, the voltage of the battery cell of the battery pack is read (e.g., by the battery gauge). At step 1014, a processor of the charging device may set the voltage output to the power line as Vout=Vcell+dV. At step 1016, high-z input is set on the third line to enable charging of the battery pack by the charging device (e.g., the third line is released to enable the charging).

At step 1018, the third line may be set as output (e.g., 3_L associated with the battery gauge 606 of FIG. 6), such that an interrupt signal (e.g., through the third line) may be transmitted to the charging device.

At step 1020, a determination is made as to whether the interrupt signal (e.g., the interrupt signal being ALRT_OUT) has been asserted. For example, a determination may be made as to whether the interrupt signal was received by the charging device. When the third line (3_L) interrupt signal (ALRT_OUT) is asserted, battery registers may be read through the digital bus (2_L), such that the point 6 of the pseudo-code shows that registers are reading register based on the interrupt signal (coming from battery pack) is asserted. In this way, the charging device remains in a stationary state until the battery pack provides (through the third line) operating instructions to the charging device.

Upon assertion of the interrupt signal, a determination is made, at step 1022 as to whether to increase charging power, based on operating instructions of the battery pack. The voltage output from the charging device is increased at step 1028 (e.g., increased based on instructions from the battery pack) upon the determination to increase the charging power.

If the charging power is not to be increased, at step 1024, a determination is made whether less charging power is to be provided to the battery pack, based on operating instructions of the battery pack. The voltage output from the charging device is decreased at step 1030 upon determining to decrease the charging power.

If the charging power is not to be decreased, at step 1026, a determination is made as whether a stop charging command has been received by the charging device from the battery pack.

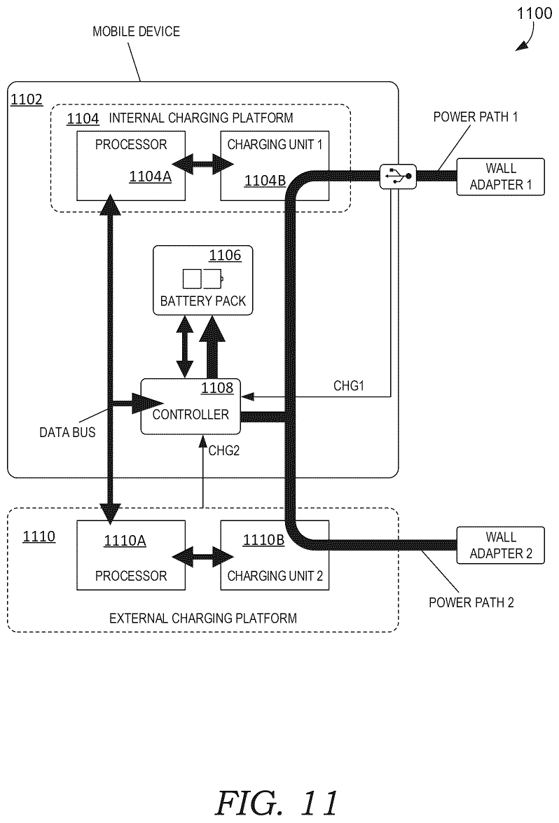

FIG. 11 illustrates an embodiment of battery charging interface 1100. FIG. 11 is an example on how to use the battery pack (e.g., battery pack 102 of FIG. 1) and it's charging method. Mobile devices are usually charged using their internal charging platform, managed by its internal processor. Battery charging interface 1100 of FIG. 11 illustrates how a mobile device may be charged using external charging platform 1110 while maintaining compatibility with the internal charging platform 1104 of FIG. 11.

The battery charging interface 1100 includes mobile device 1102, which has an internal charging platform 1104 comprising a processor 1104A and charging unit 1104B, battery pack 1106, and controller 1108. The battery charging interface 1100 also includes external charging platform 1110 having a processor 1110A and charging unit 1110B. The battery charging interface 1110 is functionally the element 120 of FIG. 1. The battery charging interface 1100 is an example on how to use the battery pack and charging method. Battery-driven portable devices are usually charged using their internal charging platform, managed by its internal processor. Charging interface 1100 describes how portable devices can be charged using the external charging platform 1110 and maintain compatibility with the internal charging platform 1104.

The battery charging interface 1100 comprises a first charging path (e.g., power path 1) associated with a first external adapter (e.g., wall adapter 1), the internal charging platform 1104 of the mobile device 1102, and the controller 1108 of the mobile device 1102. The mobile device 1102 may be connected to the first external adapter (e.g., through a universal serial bus port), and the charging of the mobile device 1102 (CHG1) may be controlled by the internal charging platform 1104. For example, the processor 1104A may communicate with the battery pack 1106 through a data bus. The processor 1104A may set registers of the charging unit corresponding to the first external adapter so that the processor 1104A may adjust the power flow.

The battery charging interface 1100 may also comprise a second charging path (power path 2) associated with the controller 1108 of the mobile device 1102, a second external adapter (wall adapter 2), and an external charging platform 1110 that is external to the mobile device 1102. The external charging platform 1110 may have a processor 1110A and a charging unit 1110B. The processor 1110A may manage the charging process of the mobile device 1102 (CHG2) by communicating with the charging unit 1110B and the battery pack 1106 using the data bus in the mobile device 1102.

In embodiments, the battery pack 1106 may be the battery pack 102 of FIG. 1, the battery pack 202 of FIG. 2, the battery pack 302 of FIG. 3, the battery pack 402 of FIG. 4, the battery pack 502 of FIG. 5, or the battery pack 602 of FIG. 6.

Each of the internal charging platform 1104 and the external charging platform 1110 share the same data bus within the mobile device 1102 for communications with the controller 1108 and the battery pack 1106. As such, the controller 1108 may coordinate the power flow and the communication data among the battery pack 1106, the internal charging platform 1104, and the external charging platform 1110 based on this data bus. In embodiments, to recognize a connection with the first external adapter and the external charging platform 1110, control signals (e.g., CHG1 and CHG2) can be used.

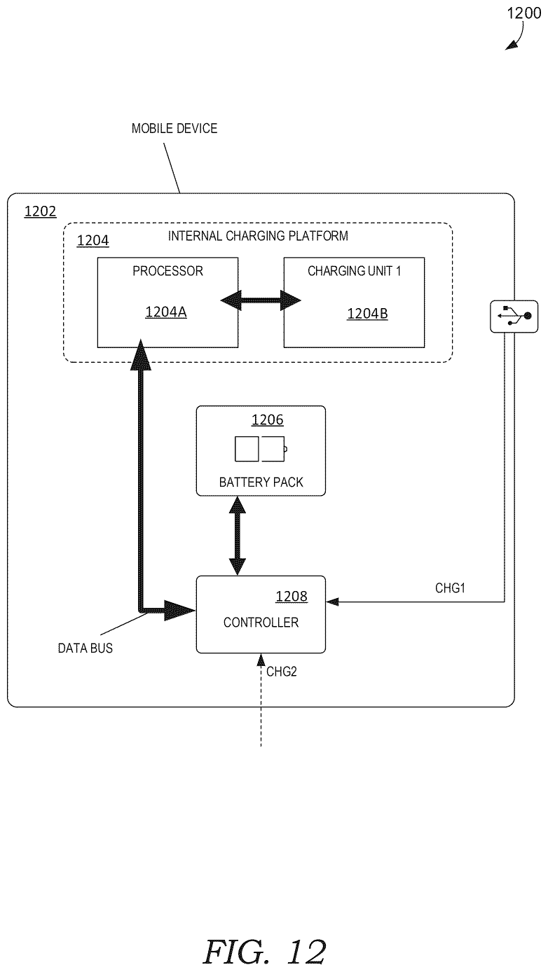

FIG. 12 illustrates an embodiment of battery charging interface 1200 for the mobile device 1202. The mobile device 1202 comprises an internal charging platform 1204 having a processor 1204A and charging unit 1204B, battery pack 1206, and controller 1208. FIG. 12 illustrates an embodiment for CHG1 LOW and CHG2 LOW. For example, in this embodiment, there are no chargers connected to the device, and no power paths that are enabled for charging. In this embodiment, the processor 1204A communicates with the battery pack 1206 through the bus, the processor 1204A reading registers about the status of the battery pack 1206. To illustrate, the CHG1 and CHG2 notify the controller 1208 that no chargers are connected to the mobile device 1202. The processor 1204A can then read the status of the battery pack 1206, and transmit that status (e.g., state of charge, state of health of the battery cell in the battery pack 1206) to a user interface of the mobile device 1202.

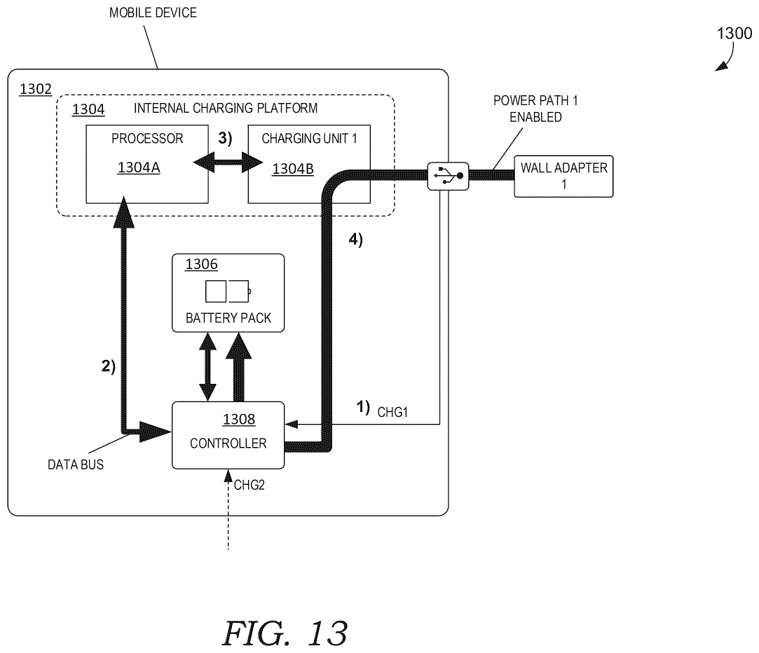

FIG. 13 illustrates an embodiment of battery charging interface 1300 for the mobile device 1302. The mobile device 1302 comprises an internal charging platform 1304 having a processor 1304A and charging unit 1304B, battery pack 1306, and controller 1308. FIG. 13 illustrates an embodiment for CHG1 HIGH and CHG2 LOW. For example, in this embodiment, a universal serial bus cable (or another type of connection or cable) may be connected with the mobile device 1302, and the controller 1308 detects the signal CHG1 based on the connection with the universal serial bus cable (or another type of connection or cable). The processor 1304A can determine a status of the battery pack 1306 (e.g., a temperature of the battery cell of the battery pack 1306, a temperature of the battery pack 1306, state of charge of the battery cell, state of health of the battery cell, voltage, etc.) based on the detection of the signal CHG1. In addition, the processor 1304A may set parameters of the charging unit 1304B (e.g., charging current, termination current, charging voltage, etc.) and enable power flow to initiate through the power path 1.

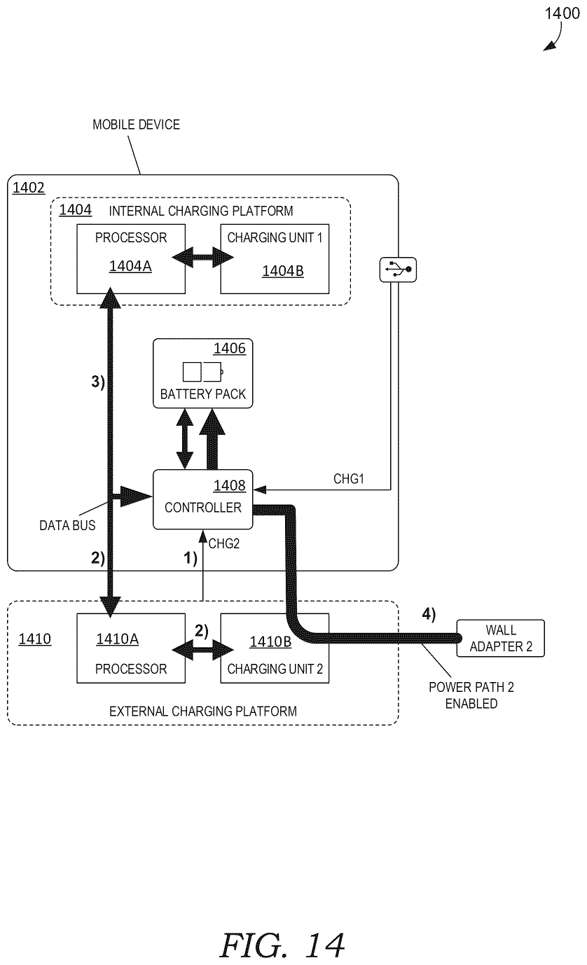

FIG. 14 illustrates an embodiment of battery charging interface 1400 for the mobile device 1402. The mobile device 1402 comprises an internal charging platform 1404 having a processor 1404A and charging unit 1404B, battery pack 1406, and controller 1408. The battery charging interface 1400 also includes external charging platform 1410 having a processor 1410A and charging unit 1410B. FIG. 14 illustrates an embodiment for CHG1 LOW and CHG2 HIGH. For example, in this embodiment, the controller 1408 may detect the external charging platform 1410 based on the CHG2 pin, and the controller 1408 may enable charging of the mobile device 1402 through the external charging platform 1410 through the power path 2. While concurrently enabling the power path 2, or before enabling the power path 2, the controller 1408 may disable the charging unit 1404B without disabling the processor 1404A. In this way, the processor 1404A may still determine the status of the battery cell in the battery pack 1406 as the charging unit 1404B is disabled. As another example, the processor 1404A may still transmit that status (e.g., state of charge, state of health of the battery cell) to a user interface of the mobile device 1402 as the charging unit 1404B is disabled.

In embodiments, the charging unit 1404B of the internal charging platform 1404 may be disabled by the controller 1408 upon charging through the second external adapter and the power path 2, and the processor 1404A of the internal charging platform 1404 may continue to determine the status of an internal battery of the mobile device 1402 upon charging through the second external adapter and the power path 2. In some embodiments, computer-readable storage media of the internal battery of the mobile device 1402 may cause the processor 1404A to increase receipt of power supply (through the second external adapter and the power path 2) from the external charging platform 1410 based on the status of the internal battery. As another example, computer-readable storage media of the internal battery of the mobile device 1402 may cause the processor 1404A to decrease receipt of power supply (through the second external adapter and the power path 2) from the external charging platform 1410 based on the status of the internal battery (e.g., the temperature of the battery being above a threshold).

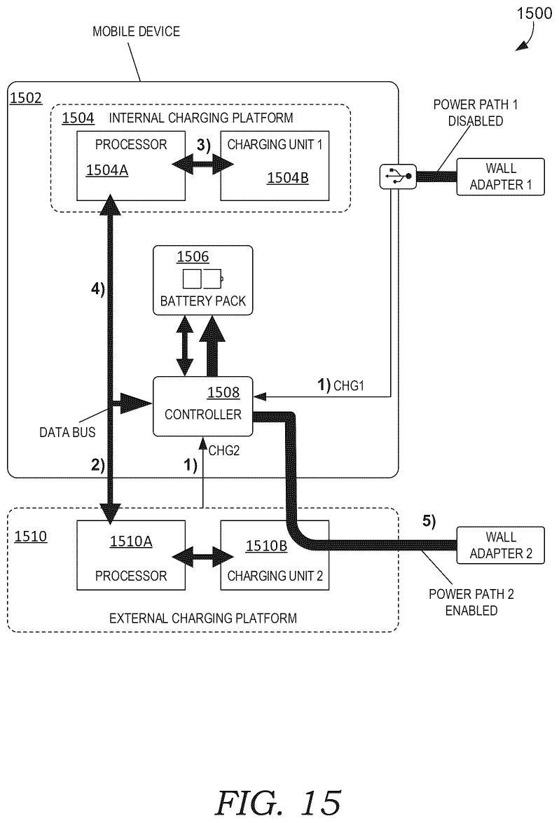

FIG. 15 illustrates an embodiment of battery charging interface 1500 for the mobile device 1502. The mobile device 1502 comprises an internal charging platform 1504 having a processor 1504A and charging unit 1504B, battery pack 1506, and controller 1508. The battery charging interface 1500 also includes external charging platform 1510 having a processor 1510A and charging unit 1510B. FIG. 15 illustrates an embodiment for CHG1 HIGH and CHG2 HIGH. For example, in this embodiment, the controller 1508 detects the signals of each of the CHG1 and CHG2.

In embodiments, the controller 1508 may determine (e.g., based on computer-readable storage media of the internal battery of the mobile device 1502) that the external charging platform 1510 has a higher priority than the internal charging platform 1504. In some embodiments, the controller 1508 may determine (e.g., based on computer-readable storage media of the internal battery of the mobile device 1502) that the charging unit 1510B has a higher priority than the charging unit 1504B. In some embodiments, the controller 1508 may determine (e.g., based on computer-readable storage media of the internal battery of the mobile device 1502) that the CHG2 has a higher priority than the CHG1. In some embodiments, the controller 1508 may determine (e.g., based on computer-readable storage media of the internal battery of the mobile device 1502) that the power path 2 has a higher priority than the power path 1. In this way, the charging unit 1504B is disabled while the processor 1504A still determines the status of the battery of the mobile device 1502.

Based on the higher priority (e.g., the external charging platform 1510 having the higher priority than the internal charging platform 1504), the external charging platform 1510 begins to charge the mobile device 1502, the processor 1504A determines the status of the battery, and the processor 1504A or the processor 1510A determines the settings for charging unit 1510B as the external charging platform 1510 charges the mobile device 1502. Additionally, the charging unit 1504B is disabled (e.g., based on the external charging platform 1510 having the higher priority than the internal charging platform 1504). Based on the charging unit 1504B being disabled, the power flow through the power path 2 may be initiated.

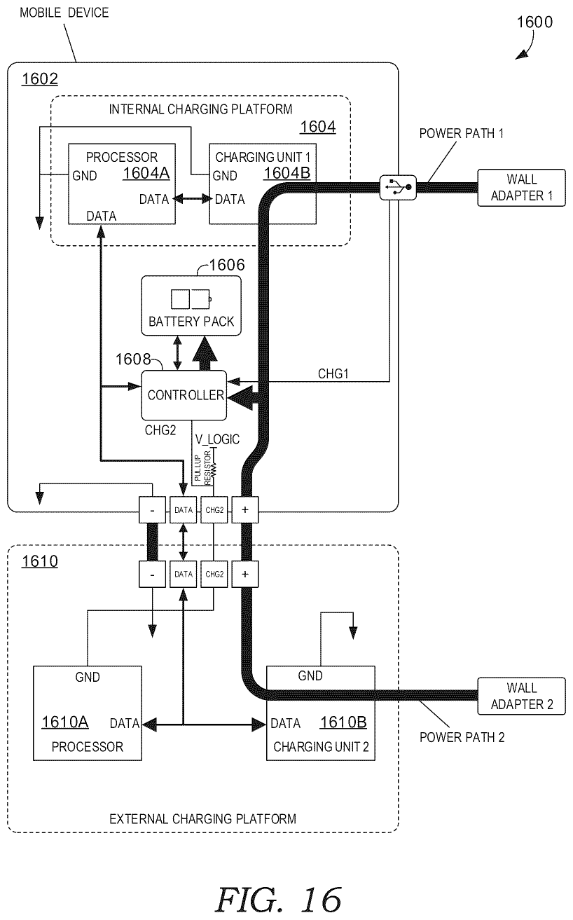

FIG. 16 illustrates an embodiment of battery charging interface 1600 for the mobile device 1602. The mobile device 1602 comprises an internal charging platform 1604 having a processor 1604A and charging unit 1604B, battery pack 1606, and controller 1608. The battery charging interface 1600 also includes external charging platform 1610 having a processor 1610A and charging unit 1610B.

When the mobile device 1602 is not in contact with or connected to the external charging platform 1610, CHG2 is HIGH, and may be pulled-up with a pull-up resistor through a logic power supply. In some embodiments, the signal CHG2 (3L_LINE of CHG device 120) is the signal that triggers to the battery the presence of the external charging platform 1610 and it can be an electrical pin or any other type of signal coming from sensors like a Hall effect sensor, a proximity sensor, or any type of presence sensor. When the external charging platform 1610 is in contact with or connected to the mobile device 1602, CHG2 is LOW, pulled down to GND through the external CHG2 contact, and is then sent to the controller 1608. In some embodiments, one or more electrical conventions (Hi-Z, Tri-State, etc.) may be used to manage the CHG2 pin so that the controller 1608 may determine the presence or absence of the external charging platform 1610.

In embodiments, the charging phase may be customized using the external charging platform 1510 (e.g., by increasing the current up to 10 A or another current compatibly with the battery cell of the mobile device, by implementing one or more high speed charging algorithms (e.g., step charge), by reducing the charging time, etc.).

In these ways, the external charging platform 1610 may operate in parallel with various internal charging platforms of various mobile devices.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software. For instance, various functions may be carried out by a processor executing instructions stored in memory. As such, other arrangements and elements (for example, machines, interfaces, functions, orders, and groupings of functions, and the like) can be used in addition to, or instead of, those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A battery pack comprising:
a battery cell;
one or more computer-readable storage media having computer-executable instructions embodied thereon that trigger an operation by a charging device; and
a connector that provides a signal to the charging device to trigger the operation by the charging device to charge the battery pack.

2. The battery pack of claim 1, the operation by the charging device being triggered based on a charging profile stored in the one or more computer-readable storage media.

3. The battery pack of claim 1, further comprising a battery gauge, located inside a housing of the battery pack, such that the battery gauge measures battery parameters based on a sensing line connection between the battery gauge and the battery cell.

4. The battery pack of claim 3, the connector comprising a first connector component having a first line with the battery gauge, a second connector component having a second line with at least the battery gauge and the one or more computer-readable storage media, and a third connector component having a third line with the battery gauge, the third connector component being connected to a charging device connector of the charging device to provide the signal to a processor of the charging device.

5. The battery pack of claim 4, the second line being connected with the charging device connector of the charging device to provide voltage measurements to the processor of the charging device.

6. The battery pack of claim 4, wherein the signal, provided through the third connector component to the processor of the charging device, is an interrupt signal, and wherein the operation by the charging device is to provide the battery pack with power.

7. The battery pack of claim 4, the first line being connected with a power supply of the charging device through the charging device connector of the charging device.

8. A method comprising:
transmitting, by a connector of a battery pack having computer-readable storage media and without a processor, a signal to a processor of a charging device to trigger an operation by the charging device; and
based on transmitting the signal, receiving, through the connector, power from the charging device.

9. The method according to claim 8, further comprising:
transmitting, through the connector of the battery pack, an instruction to the processor of the charging device to increase the power, wherein the signal is an interrupt signal, and wherein the operation by the charging device is to provide the battery pack with power; and
based on transmitting the instruction to the processor of the charging device to increase the power, receiving increased power from the charging device.

10. The method according to claim 9, further comprising:
transmitting, through the connector of the battery pack, voltage measurement data measured by a battery gauge of the battery pack to the processor of the charging device; and
based on the voltage measurement data, receiving the increased power from the charging device.

11. The method according to claim 8, the connector of the battery pack comprising a first connector component having a first line with a battery gauge of the battery pack and connected with a power supply of the charging device, a second connector component having a second line with the battery gauge and the computer-readable storage media, the second line connected with the power supply and the processor of the charging device, and a third connector component having a third line with the battery gauge, the third line connected with the processor of the charging device, the method further comprising:
transmitting, through the second line from the battery pack, voltage measurement data and temperature data measured by the battery gauge of the battery pack to the processor of the charging device.

12. The method according to claim 11, further comprising:
transmitting, through the third line from the battery pack, an instruction to the processor of the charging device to decrease the power, wherein the signal is an interrupt signal, and wherein the operation by the charging device is to provide the battery pack with power; and
based on the voltage measurement data and temperature data, and based on transmitting the instruction to the processor of the charging device to decrease the power, receiving decreased power from the charging device.

13. The method according to claim 11, wherein the signal is transmitted to the processor of the charging device through the third line, and the power is received from the charging device through the first line.

14. A battery charging interface comprising:
a first charging path associated with a first external adapter, an internal charging platform of a mobile device, and a controller of the mobile device; and
a second charging path associated with the controller of the mobile device.

15. The battery charging interface of claim 14, the internal charging platform comprising a processor and charging unit.

16. The battery charging interface of claim 15, the second charging path being associated with a second external adapter and an external charging platform that is external to the mobile device.

17. The battery charging interface of claim 16, the charging unit of the internal charging platform being disabled by the controller upon charging through the second external adapter, and the processor of the internal charging platform determining a status of an internal battery of the mobile device upon charging through the second external adapter.

18. The battery charging interface of claim 17, wherein computer-readable storage media of the internal battery cause the processor to increase receipt of power supply from the external charging platform based on the status of the internal battery.

19. The battery charging interface of claim 16, further comprising a pin that is used for the mobile device to detect the presence of the external charging platform.

20. The battery charging interface of claim 16, further comprising a Hall effect sensor that is used for the mobile device to detect the presence of the external charging platform.
